(19) United States
(12) Patent Application Publication
(10) Pub. No.: US 2026/0114481 A1
(43) Pub. Date: Apr. 30, 2026

(54) EDIBLE BEEF HIDE PROCESSING METHOD, SYSTEM, AND PRODUCT

(71) Applicant: Siewe S. Siewe, Stillwater, OK (US)

(72) Inventor: Siewe S. Siewe, Stillwater, OK (US)

(21) Appl. No.: 19/372,943

(22) Filed: Oct. 29, 2025

Related U.S. Application Data
(60) Provisional application No. 63/713,664, filed on Oct. 30, 2024.

(51) Int. Cl. A23L 13/20; A23B 4/005; A23L 5/10; A23L 5/20

(52) U.S. Cl. CPC A23L 13/20; A23B 4/005; A23L 5/10; A23L 5/13; A23L 5/21

(57) ABSTRACT

A commercial system and method for producing an edible beef hide product wherein raw beef hides are prepared for cooking and then heated to cook and soften the hides, with the cooked beef hides then being washed with scrubbing and/or agitation and cooled, all in a manner meeting food safety requirements, to provide not only the level of safety, but the flavor, color, texture, and other qualities, which the consumers of these products desire.

### RELATED CASE

This application claims the benefit of U.S. Provisional Patent Application No. 63/713,664 filed Oct. 30, 2024 and incorporates the provisional application herein by reference in its entirety as if fully set forth at this point.

### FIELD OF THE INVENTION

The present invention relates to a processing method and a processing system for producing edible beef hide products, and to edible beef hide products produced by the processing method and system.

### BACKGROUND OF THE INVENTION

Although homemade edible beef hide products are prepared and consumed in numerous locations around the world, such products (i) are produced by individuals on a small scale and (ii) would not satisfy food safety standards such as those in the U.S. A need therefore exists for a food processing system and method which is safe and effective for producing high quality edible beef hide products, on a large scale, at low cost, for sale to consumers in supermarkets and elsewhere.

### SUMMARY OF THE INVENTION

The present invention provides a food processing system and method which satisfy the needs and alleviate the problems mentioned above. The inventive system and method are effective for producing a high quality edible beef hide product on a large scale, at a low cost, for sale to consumers. Moreover, the edible beef hide product produced by the inventive method and system not only satisfies food safety requirements, but has the flavor, color, texture, and other qualities which consumers of these products desire.

In one aspect, there is provided a method of producing an edible beef hide product comprising the steps of: (a) heating beef hides to cook and soften the beef hides; (b) washing the beef hides, after cooking in step (a), with scrubbing and/or agitation; and (c) cooling the beef hides during and/or after step (b).

In another aspect, the method can also include: sorting the beef hides by thickness, size, age, breed, color, and/or soil level prior to step (a); dipping the beef hides in heated water prior to step (a) to remove hair; removing hair prior to step (a) using a scraping machine, a skinner, a shaver, or a shearing-type powered trimmer; washing the beef hides with scrubbing and agitation in step (b) in a tumble washer comprising a drum having brushes therein which contact the beef hides while the drum is rotating; and/or portioning the beef hides into smaller pieces after step (c).

Further objects, features, and advantages of the present invention will be apparent to those in the art upon examining the accompanying drawings and upon reading the following Detailed Description of the Preferred Embodiments.

### BRIEF DESCRIPTION OF THE DRAWINGS

FIG. 1 is a flow diagram illustrating the inventive method and system for producing an edible beef hide product.

FIG. 2 depicts a tumble-style washer 22 with scrubbing brushes 24 therein.

### DETAILED DESCRIPTION OF THE PREFERRED EMBODIMENTS

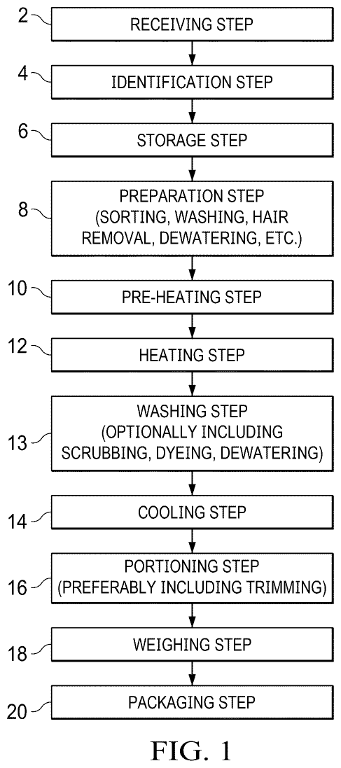

An embodiment of the inventive method and system for producing an edible beef hide product is illustrated in FIG. 1. The inventive method and system preferably comprise: a step 2 of Receiving the beef hides at the processing facility; a step 4 of Identifying the beef hides; a step 6 of Storing the beef hides prior to preparation; a step 8 of Preparing the beef hides for further processing; a step 10 of Pre-Heating; a step 12 of Heating; a step 13 of Washing the beef hides; a step 14 of Cooling; a step 16 of Portioning; a step 18 of Weighing; and a step 20 of Packaging.

It will be understood, however, that (i) the order of at least some of the steps of the inventive method and system can be changed, (ii) some steps can be deleted, and (iii) additional steps can be added.

In the Receiving step 2 of the inventive method and system, beef hides are received at the processing facility for processing to produce an edible food product for human consumption. Hides are handled and stored with the same general care as a food ingredient. The hides can be salted for storage but in at least some cases, salting may not be necessary, or beneficial, for edible hides. The hides will preferably be refrigerated if stored for more than 1 hour. The Receiving step 2 preferable receives hides from an on-site abattoir or other abattoirs located within a reasonable distance of the edible hide processing facility.

In the Identification step 4 of the inventive system and method, the hides will preferably be identified with an attached barcode or other label that is secured to the hide in the abattoir. If a barcode or label is not attached, one is assigned and attached to each hide. During the Identification step 4, the barcode or label is logged into the materials tracing system of the hide processing operation. Normally, the hide identification information is linked to the barcode or label attached to the animal carcass, or side, and is traceable to the point of origin of the animal. Such identification of hides for edible hide processing or other purposes has not been done previously and preferably also includes, for example, an identification and record of the grower name and location, animal age, medications, harvest location, time, date, and information related to traceability.

In the Storage step 6 of the inventive method and system, the hides are preferably stored, as received, under refrigeration. Storage methods are designed to optimize cooling and handling. Examples of methods include, but are not limited to, racks, layers, spaced layers, containers, dry storage, and wet storage. Preferably, the hides will not be frozen or salted for storage when a dip method is subsequently used to remove hair. I have discovered experimentally that it is more difficult to remove hair from frozen hides using the dip method. This discovery was surprising and unexpected. Moreover, the elimination of salt and similar preservative agents can be beneficial for human consumption of the edible hide product.

In the Preparation step 8 of the inventive method and system, one or more steps may be undertaken to prepare the hides for further processing. As received, beef hides are subject to variation, including soil, foreign materials, packaging, physical properties (e.g., thickness, hair quality, color, attached tissue, shape, size, temperature, age, etc.) and treatments (salting, refrigeration, rinsing, washing, and trimming). Preparation steps can therefore be used, e.g., to clean, identify and ameliorate or remove undesirable variations.

As an example of one preparation step, the hides can be sorted to classify the hides according to one or more physical properties like thickness, size, age, breed, color, and soil level. Sorting provides improved processing efficiency by reducing the need to change machine settings and enabling the processor to maintain the same processing steps. For example: (1) because a skinner must be set according to the thickness of the hide, running hides of the same thickness is an advantage when using a skinner; (2) hides that are received in a clean condition require little or no washing steps; (3) hide color has been correlated with various quality aspects of the final product, including thickness and texture; and (4) hides of similar thickness and hair properties will have a similar dwell time and temperature setting for the dip tank. Such sorting of hides to make a human-edible product has not been done heretofore.

Another example of a preparation step involves washing the hides to remove soils and foreign materials (collectively referred to as soil). Washing the hides can comprise, e.g., contacting the hides with water via dipping and/or spraying. The water may contain food-grade chemicals that help remove soil. Examples of additives are soaps, acids, release agents, wetting agents, and sequestrants. Mechanical agitation may also be used to help remove the soil. Examples of mechanical agitation include, but are not limited to, stirring, water jets and streams, brushes, rollers, and scrubbing balls or shapes. Washing hides in this manner has not been used heretofore for making edible beef hide products.

Another example of a preparation step for the hides involves dipping the hides in heated water to aid removal of hair. I have discovered through experimentation that fresh, unfrozen hides can be dehaired more efficiently when dipped in about 140° to about 160° F. (i.e., ±5°) water for from about 2 to about 10 minutes (i.e., ±5%). Dipping in heated water at this temperature for this amount of time is effective for loosening hair without curling the hide. Hide curling is a problem for subsequent processing steps. The dip tank may be agitated and may contain chemicals (e.g., a cleaning agent, wetting agent, and/or sequestrant) to help clean the hide and aid in water penetration to the root of the hair follicles.

The dipping water is preferably heated and recirculated in a dip tank to maintain a uniform temperature. A filtration system is preferably included in the water recirculation loop to capture and remove loose hair follicles. The filtration system prevents clogs in the recirculation system. A screen is also preferably used to separate loose hair from the water in the tank. Dipping hides in this manner to remove hair to make an edible hide product has not been done heretofore.

Another example of a preparation step involves removing hair from the hides. This process can be performed, e.g., by hand or with a scraping machine, a skinner, a shaver, or a shearing-type powered trimmer. When using a scraping machine, the hide will preferably be attached to a rotating drum that rotates the hide past revolving rubber fingers that remove the hair. The drum roll speed, scraping finger clearance, and the rotational speed of the scraping fingers of the scraping machine can be adjusted as needed for effective hair removal.

A skinner, on the other hand, will “peel off” a layer of the hide (e.g., the surface layer containing the hair) using a rotating blade. An example of a commercially available skinner which is suitable for use in the inventive system and method for removing hair from the hides is a Townsend Model 7600 skinner sold by Townsend Engineering. For the skinner, the blade clearance and feed roll speed can be adjusted as needed for effective hair removal.

The use of scraping, skinning, or shearing machines such as these in this manner to remove hair for producing edible hide products has not been done heretofore.

Another example of a preparation step involves dewatering the hides to facilitate subsequent processing. Removal of surface water reduces the energy requirement for heating and cooling steps and makes the hide easier to manage. Dewatering processes include, but are not limited to: drip-dewatering, where the hide is hung in a refrigerated space and excess water drips off; roll-dewatering, where the hide is pinched between rollers to squeeze-out and force off excess water; shake dewatering, where the hide is manipulated to shake off excess water; and heat dewatering, where heat is applied to dry the hide. The use of dewatering in this manner to produce edible hides has not been known heretofore.

In the Heating step 12 of the inventive system and method, a thermal treatment is used to soften, cook, develop color, modify texture, and/or prepare the hide for further processing, as well as providing a lethality step which inactivates microorganisms for improved food safety. Heating may be accomplished using a variety of methods or combinations thereof. Examples of suitable heating methods include convective, radiative, and conductive heat transfer via electric heating elements, flames, air circulation, steam, condensation, evaporation, and recirculated thermal fluids. Other heating methods may include microwave, plasma, and ohmic heating.

In the Heating step 12, heat is preferably used to cook the hide, which softens the texture and changes the color. The complex protein matrix of the hide material breaks down under heat, resulting in softening and flavor development. Heat also melts and separates fats from the hide. In the case of open flame, care must be taken to manage flare-ups caused by ignition of fat. Burning fat boils and pops and can spread fire quickly. Burning fat is dangerous to operators, equipment, and the facility. Consequently, flameless heating is more preferred in order to prevent the ignition of fat.

Heating can cause the hide to curl due to the natural tendency of the surface of the hide to shrink more rapidly on the side which is heated. Consequently, to substantially prevent or at least reduce curling, the hide will preferably be maintained in a flat, or uncurled condition, to facilitate even application of heat and subsequent processing steps. Preferred methods developed and used in the inventive system and method to prevent the hide from curling include: heating the hide between two, heavy steel plates at 750 to 1,250 degrees F.; holding the hide flat between two mesh screens; or holding the hide flat on a conveyor surface using a heavy metal plate.

In the conduction method for heating and singeing a beef hide, the hide is captured between two steel plates heated red-hot by a natural gas burner. The conduction heater can heat and singe the hide simultaneously. It can also heat and cook hides that have been dehaired.

Steam heating is also effective for use in the inventive system and method for heating/processing the beef hides for producing an edible product. I have discovered that steam heating will quickly and efficiently cook beef hides while maintaining moisture and a higher portion of the fat content, compared to dry heating methods. Steam also kills microorganisms faster than dry heat. Steam does not, however, promote color development (browning) in the final product. One preferred method of steam heating the hides is to steam heat the hides in a Spiral Oven.

Heating hides in accordance with the procedures described herein without an open flame has not been done heretofore for producing an edible hide product.

The inventive system and method will also preferably include a Pre-Heating step 10 conducted prior to the Heating step 12. The Pre-heating step 10 can use waste heat, for example, to improve the energy efficiency of the process. Waste heat can be transferred, for example, from hot water or hot air discharged from various points in the Heating process or elsewhere.

The Pre-Heating step 10 may be used to make the hide easier to manipulate and manage during the Heating process 12. Pre-Heating is also used to slow the overall heating process in order to better develop the desirable physical properties of the product.

Another objective and benefit of the heating process, or as a separate step performed elsewhere in the inventive method and system, is pasteurization. For pasteurization, the heating process will also preferably include the aspect of heating the hide material to achieve a given or targeted level of microbiological deactivation/lethality. The level of inactivation is normally measured by microbiologists using a logarithmic scale. For example, a 5-log process will reduce the microbial population by 100,000 times. The required inactivation level is determined based on factors like the initial microbiological load, shelf life, pH, water activity, and consumer handling.

Heat for pasteurization can be quickly applied as described above or by other processes using steam, conduction, hot water, or other methods to reach a target internal core temperature between 145° to 165° F., preferably about 155° F., and hold the temperature for 72 seconds to achieve a 5-log reduction in a theoretical microbiological population. Heretofore, pasteurization of hides to make a human-edible product has not been known. Pasteurization will increase product shelf life and make the product safer for consumers.

Following the Heating step 12, the inventive method and system will preferably include a Cooling step 14. The removal of heat from the hide material to reach a low target temperature causes microorganisms to multiply more slowly and therefore helps to preserve the quality of the food product. In the inventive system and method, chilled water and ice are preferably used to quickly cool the beef hide material to a temperature which is preferably not more than 45° F. but not less than 30° F., more preferably about 34° F. Agitation can also be used in the chilling step 14 to speed cooling and provide better uniformity.

As another option, refrigerated air or other air can alternatively be used for performing the Cooling step 14. Similar to a water chill step, an air chill step will preferably involve using directed airflow to chill the hide to the same target temperature. The air may or may not be chilled. Ice can be used to chill the air or the air can be chilled in a more conventional manner by refrigerant evaporation.

Controlled chilling of hides as described herein has not been used heretofore to make an edible beef hide product.

As part of the Heating step 12 or at some other point of the inventive method and system, grill marks can be applied to the edible beef hide product. Grill marks are, or at least resemble, the imprints from a hot grill made on a product. They are normally dark to black lines that correspond to the “mesh” or bars of a grill surface. Grill marks are important for the visual appeal of the product and give the appearance that it was carefully grilled over an open flame. Customers expect grill marks on edible beef hide and the marks can be made, for example, using an actual grill itself, or by using a heated searing wheel. Another option is to make the grill marks on the beef hide using a conveyor belt (metal mesh) pattern and/or by a searing roller or wheel that contacts the product as it moves through an oven.

The inventive system and method preferably also comprise a Washing step 13 which is preferably performed between the Heating step 12 and the Cooling step 14 and/or as part of the Cooling step 14. The hides are washed to remove loose materials and sometimes to simultaneously chill the hides when cold water is used for washing. Other processes and treatments, like scrubbing, dyeing, and dewatering, may also be performed in this phase of the process.

In the Washing step 13, the beef hide pieces are preferably washed with clean, softened water to remove loose materials. Potable water is preferably filtered and softened to remove scale, foreign materials, and dissolved minerals. Examples of chemicals which can be added to the water to aid the washing process include: soap, a sequestrant, a dispersant, an enzyme, a whitener, and other agents designed to condition the water and remove unwanted materials.

The water, with any additives included therein, is preferably applied to the beef hide pieces by immersion and/or spray methods. The additives may be combined with the water outside of the washing system. Agitation is preferably used in the washing process. Agitation may be produced by water jets, a mixer, a tumbler, or other suitable devices. The water may be recycled to reduce water usage and energy requirements.

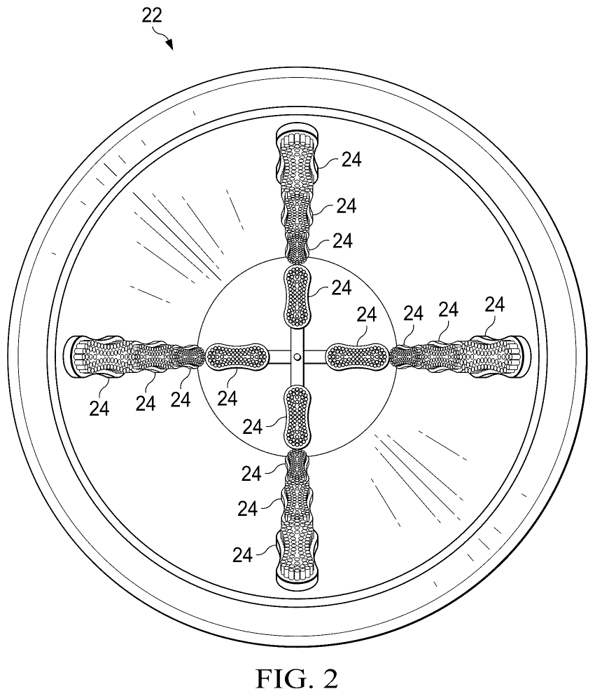

A tumble-style washer 22 which can be used in the Washing step 13 is illustrated in FIG. 2. The washer resembles a front-loading clothes washer, and operates in a similar manner. The washer drum is outfitted with fixed brushes 24 that contacted the beef hide pieces while the drum is spinning. The brushes 24 help to loosen soil on the beef hide pieces. The wash cycle preferably comprises multiple rinse and washing steps. In general, a rinse step is preferably followed by a wash step, which is preferably followed by another rinse.

As an example of another alternative, a pressure washing technique can be used where the beef hide pieces are fixed on a rack or table and pressure washed by hand using tap water at from about 1,000 to about 3,000 psi, and preferably at about 2,200 psi.

As an example of yet another alternative, a washing/scrubbing table can be used where the operator hand feeds the pieces of beef hide into the unit and the hide pieces are automatically captured and moved by rotating brushes that scour the top and bottom of each piece. High-pressure water spray nozzles also help to remove unwanted materials and debris.

Automated and semiautomated hide washing systems and apparatuses such as those described above provide high throughputs and have low labor inputs. Automated and semi-automated hide washing techniques as described herein (i) have not been used heretofore for producing edible hide products and (ii) also reduce water and chemical consumption and improve the quality and safety of the product.

Simultaneous washing and chilling can incorporate any or all of the washing methods described above with chilled water being used to simultaneously cool the beef hide while washing. The chill portion of the wash and chill cycle may take place during a specific portion of the wash cycle, for example, the final rinse. Ice may be added to the water to facilitate chilling. The ice may also serve as an abrasive to help remove foreign material during the wash process.

Scrubbing during the Washing step 13 can use equipment like brushes, balls, or paddles to mechanically contact the beef hide pieces to remove unwanted materials. These and other options include, but are not limited to, manually scraping, using hand-held brushes, using fixed brushes in a tumbler, using balls or shapes in a tumbler, using rotating brushes, and using water jets to accomplish the scrub process.

Targeted scrubbing can be used to focus on specific areas or an entire side of a beef hide. Targeted scrubbing is an efficient step of removing specific marks or materials and can be used to achieve a desired finish and appearance of the beef hide.

Concerning the use of dyes, based upon results from expert sensory panels, a golden-brown edible beef hide product is preferred over paler or whiter alternatives. A golden-brown color of the beef hide can be developed during a flame-heating process. However, for safety reasons as mentioned above, although flame-heating can be used in the inventive system and method, it is less preferred than other heating techniques.

Steam heating, on the other hand, is a preferred option due to quality and safety issues as previously described but does not develop a brown color. However, to overcome this deficiency of steam heating or other heating techniques, dyes can be used to achieve a more uniform golden-brown color. Natural, label-friendly dyes, like tea extract, can be used to color the hide without imparting undesirable flavors or impacting the product label declaration.

The Cooling (chilling) step 14 described above prepares the edible hides for subsequent portioning and packaging steps and preferably produces a rapid drop in temperature that does not support microbial growth.

Other processes, like dewatering, may also be performed during the chill phase, depending on the chilling method selected. Cooling hides with chilled water to make a human-edible product has not been done heretofore.

The inventive method and system also preferably comprise a Portioning step 16 in which the hides are divided into smaller pieces. The hide pieces in most cases will preferably be of the same or very similar size and dimensions, but may be of unique sizes based on raw materials, processing, and handling conditions. Portioning may be manual, automated, or semi-automated. The goal of the portioning process will preferably be to cut the beef hide into pieces ideal for the end user. Preferably, the pieces will be roughly square or rectangular and the sides thereof will preferably be in a range of from 5 cm to 30 cm in length. The target dimensions can also be up to 45 cm or more for large-sized packages.

The hide pieces will also preferably be trimmed using, e.g., a knife, scissors, razor blade, rolling blade, powered knife, trimmer, guillotine, cutter bar, laser, water jet, or similar device. Trimming involves cutting away smaller pieces of the hide that may be imperfect or unsalable. Trimming may also require cutting off small pieces to make the shape of the larger portion of the hide more uniform (e.g., square or rectangular). The trimmings can be collected and sold as a similar product (e.g. hide trimmings). Heretofore, edible hide trimmings have not been sold as a separate product.

In the Portioning step 16, trimmed or untrimmed pieces of hide are cut into portions using the same or similar tools as described in the trim step above. Portioning involves cutting hide pieces to a size or sizes that are more desirable and directly useful to the end user (cook or chef). Portioned pieces of beef hide should be of relatively uniform size and/or size distribution in the primary package. Heretofore, edible hide pieces have not been portioned for sale. Proportioned hide pieces are more desirable and more convenient for the end user.

Following the Portioning step 16, the inventive method and system preferably comprise a Weighing step 18 in which trimmed and portioned hide pieces are collected into a group appropriate for the package size and weighed. The group weight will be adjusted by adding or removing pieces. Packages are sold by net weight. The target net weight will preferably be accurate to ±2, −0 grams. Weighing may be accomplished manually, with automated equipment, or in a semi-automated process.

Prior to weighing for packaging, the hide pieces can also be sorted, or separated, according to categories defined by physical characteristics. Categories include size, weight, thickness, color, and texture. Sorting may be conducted manually, with automated equipment, or in a semi-automated process. The purpose of the sorting is to make packages more uniform and appealing to consumers.

In the Packaging step 20 of the inventive system and method, the portioned beef hide pieces are preferably packed in a primary packaging material, followed by secondary packaging, tertiary packaging, and other packaging levels as required for storage, shipping, meeting customer standards, and food safety needs. The primary packaging step preferably involves placing the beef hide pieces into the primary packaging, such as vacuum bag. The primary packaging material directly contacts the product. The primary packaging protects the product from contamination and environmental degradation. Packaging may be undertaken manually, automatically, or semi-automatically.

After the primary packaging step, a metal detector is preferably used to detect and identify foreign materials in the package that are electrically conductive. It will be understood, however, that metal detection can alternatively or additionally be used at other points in the inventive system and process. Examples of foreign materials that might be present in the product include metals and metal-detectable gloves, gaskets, and similar materials. A metal detector is often a required inspection element for food safety. However, heretofore, metal detection of edible beef hide has not been applied, or necessary, since beef hide has not been sold under USDA inspection or global food safety standards.

The packages of the inventive edible beef hide product can optionally be placed in cartons. A carton is a container that holds a specified number of packages and is known as a minimum unit of stock for the product. The product is not normally sold in quantities less than the number contained in a carton. Although not a requirement of the present invention, a carton will typically contain anywhere from 6 to 20 packages, preferably 12. Cartons are normally constructed of paperboard and are sealed with glue or tape. Cartons are opened at retail distributors to stock store shelves. The primary packages are sometimes left in the cartons as a point of display, and/or to reduce handling requirements. Cartons are marked with a barcode and printing corresponding to the contents and requirements for identification and display.

The cartons of the inventive edible beef hide product can optionally be placed in cases. A case is a container designed to hold a specific number of cartons. A case is normally constructed of corrugated cardboard and is sealed with glue or tape. Cases are marked with a barcode and printing corresponding to the contents and requirements for identification and shipping. The cases will typically be placed on pallets for storing, handling, and shipping. Cases of products are stacked on the pallet in an organized pattern to maintain a secure and stable stack. A full pallet is stretch-wrapped to help maintain its integrity. Labels and barcodes are attached to the pallet for identification and shipping requirements.

Thus, the present invention is well adapted to carry out the objects and attain the ends and advantages mentioned above as well as those inherent therein. While presently preferred embodiments have been described for purposes of this disclosure, other embodiments, changes, and modifications will be apparent to those in the art. Such changes, modifications, and other embodiments are encompassed within this invention as set forth in the claims.

What is claimed is:

1. A method of producing an edible beef hide product comprising steps of:
a) heating beef hides to cook and soften the beef hides;
b) washing the beef hides, after cooking in step (a), with scrubbing and/or agitation; and
c) cooling the beef hides during and/or after step (b).

2. The method of claim 1 further comprising the beef hides being maintained in a flat, uncurled position while heating in step (a).

3. The method of claim 2 further comprising the beef hides being held and heated in step (a) between a pair of plates, each of the plates being heated to a temperature in a range of from 750° to 1,250° F.

4. The method of claim 1 further comprising heating the beef hides in step (a) with steam.

5. The method of claim 1 further comprising pasteurizing the beef hides in step (a) by increasing an internal temperature of the beef hides to a pasteurization temperature in a range of from 145° to 165° F.

6. The method of claim 1 further comprising, prior to step (a), sorting the beef hides by thickness, size, age, breed, color, and/or soil level.

7. The method of claim 1 further comprising, prior to step (a), dipping the beef hides in heated water to remove hair.

8. The method of claim 7 further comprising (i) the beef hides being hides which are not frozen when dipping in the heated water and (ii) the heated water having a temperature in a range of from about 140° to about 160° F.

9. The method of claim 8 further comprising the beef hides being dipped in the heated water for from about 2 to about 10 minutes.

10. The method of claim 1 further comprising, prior to step (a), removing hair from the beef hides using a scraping machine, a skinner, a shaver, or a shearing-type powered trimmer.

11. The method of claim 1 further comprising, prior to step (a), dewatering the beef hides by drip-dewatering, roll-dewatering, shake dewatering, and/or heating.

12. The method of claim 1 further comprising, prior to step (a), logging information from a barcode or label of each of the beef hides into a materials tracing system for the method.

13. The method of claim 1 further comprising the beef hides being cooled in step (c) using ice water.

14. The method of claim 1 further comprising the beef hides being cooled in step (c) to a temperature of not more than 45° F. but not less than 30° F.

15. The method of claim 1 further comprising applying grill marks to the beef hides.

16. The method of claim 1 further comprising the beef hides being washed with agitation and scrubbing in step (b) in a tumble washer comprising a drum having brushes therein which contact the beef hides while the drum is rotating.

17. The method of claim 1 further comprising the beef hides being washed with scrubbing in step (b) by pressure washing at a water pressure in a range of from about 1,000 psi to about 3,000 psi.

18. The method of claim 1 further comprising step (b) comprising using rotating brushes that scour a top and a bottom of each of the beef hides.

19. The method of claim 1 further comprising, after step (c), portioning the beef hides into smaller pieces.

20. The method of claim 19 further comprising, prior to portioning the beef hides, trimming the beef hides to cut away pieces of the beef hides that are imperfect, non-uniform, and/or unsalable.
